(19) United States
(12) Patent Application Publication
(10) Pub. No.: US 2026/0059377 A1
(43) Pub. Date: Feb. 26, 2026

(54) SRAP Control PDUs for UE-to-UE Relay

(71) Applicant: Apple Inc., Cupertino, CA (US)

(72) Inventors: Zhibin WU, Los Altos, CA (US); Alexander SIROTKIN, Hod Hasharon (IL); Fangli XU, Beijing (CN); Haijing HU, Los Gatos, CA (US); Naveen Kumar R. PALLE VENKATA, San Diego, CA (US); Peng CHENG, Beijing (CN); Ping-Heng KUO, London (GB); Ralf ROSSBACH, Munich (DE); Yuqin CHEN, Beijing (CN)

(21) Appl. No.: 19/102,312

(22) PCT Filed: Aug. 9, 2022
(86) PCT No.: PCT/CN2022/111200

§ 371 Date: Feb. 7, 2025

(51) Int. Cl. H04W 28/02; H04W 76/14; H04W 88/04

(52) U.S. Cl. CPC H04W 28/0268; H04W 28/0289; H04W 76/14; H04W 88/04

(57) ABSTRACT

A user equipment (UE) establishing a layer 2 (L2) UE-to-UE (U2U) relay operation, wherein the source remote UE and the relay UE communicate via a first sidelink (SL) and wherein the relay UE and the target remote UE communicate via a second SL. The UE generates a SL relay adaptation protocol (SRAP) protocol data unit (PDU) including a SRAP header comprising an identifier for at least the target remote UE or the source remote UE, wherein the SRAP header indicates a request, provides a measurement or provides a status with respect to the first or second SL.

### TECHNICAL FIELD

This application relates generally to wireless communication, and in particular relates to SRAP control PDUs for UE-to-UE relay.

### BACKGROUND INFORMATION

A user equipment (UE) may be configured with multiple communication links. For example, the UE may receive a signal from a cell of a corresponding network over a downlink and may transmit a signal to the cell of the corresponding network over an uplink. The UE may also be configured to communicate with a further UE via a sidelink (SL). The term sidelink refers to a communication link that may be utilized for device-to-device (D2D) communication.

The SL may be used for relay assistance, e.g., in a UE-to-network (U2N) relay, to forward data/signals between a network and a remote UE that is out of range of the network and/or has poor network coverage. For example, a relay UE that is within range of the network and/or has good network coverage may relay data/signals between the network and the remote UE via the SL connection with the remote UE. A Layer 2 (L2) relay amplifies received signals to the destination after successful decoding/encoding and demodulation/modulation of the signals. In the L2 U2N relay, the sidelink relay adaptation protocol (SRAP) refers to a sublayer located above the radio link control (RLC) layer in the protocol stack of the entities involved in the L2 U2N relay, e.g., the network (gNB), the relay UE and the remote UE.

In NR Release 18, an L2 UE-to-UE (U2U) relay is to be introduced. In the L2 U2U relay, a relay UE provides relay assistance between two remote UEs. The SRAP sublayer is to be used above the RLC layer in the U2U relay, similar to the U2N relay. The mechanisms used in the U2U relay require further specification.

### SUMMARY

Some exemplary embodiments are related to a processor of a user equipment (UE) configured to establish a layer 2 (L2) UE-to-UE (U2U) relay operation with a relay UE and a target remote UE wherein the UE is a source remote UE, wherein the source remote UE and the relay UE communicate via a first sidelink (SL) and wherein the relay UE and the target remote UE communicate via a second SL; generate a SL relay adaptation protocol (SRAP) protocol data unit (PDU) including a SRAP header comprising an identifier for at least the target remote UE, wherein the SRAP header indicates a request, provides a measurement or provides a status with respect to the first or second SL; and transmit the SRAP PDU to the relay UE on the first SL.

Other exemplary embodiments are related to a processor of a user equipment (UE) configured to establish a layer 2 (L2) UE-to-UE (U2U) relay operation with a source remote UE and a target remote UE wherein the UE is a relay UE, wherein the source remote UE and the relay UE communicate via a first sidelink (SL) and wherein the relay UE and the target remote UE communicate via a second SL; generate a SL relay adaptation protocol (SRAP) protocol data unit (PDU) including a SRAP header comprising an identifier for at least the source remote UE, wherein the SRAP header indicates a request, provides a measurement or provides a status with respect to the first or second SL; and transmit the SRAP PDU to the target remote UE on the second SL or the source remote UE on the first SL.

Still further exemplary embodiments are related to a processor of a user equipment (UE) configured to establish a layer 2 (L2) UE-to-UE (U2U) relay operation with a source remote UE and a relay UE wherein the UE is a target remote UE, wherein the source remote UE and the relay UE communicate via a first sidelink (SL) and wherein the relay UE and the target remote UE communicate via a second SL; and receive a SL relay adaptation protocol (SRAP) protocol data unit (PDU) on the second SL including a SRAP header comprising an identifier for at least the source remote UE, wherein the SRAP header indicates a request or provides a measurement with respect to the first or second SL.

### BRIEF DESCRIPTION OF THE DRAWINGS

FIG. 1a shows a diagram including protocol layers for a remote UE, a relay UE and a gNB in a layer 2 (L2) UE-to-network (U2N) relay operation.

FIG. 1b shows a SRAP data PDU used in the L2 U2N relay operation.

FIG. 1c shows a diagram of the SRAP sublayer at the PC5 interface in the L2 U2N relay operation according to one example.

FIG. 1d shows a diagram of the SRAP sublayer at the Uu interface in the L2 U2N relay operation according to one example.

FIG. 1e shows a diagram including protocol layers for a source remote UE, a relay UE and a target remote UE in a layer 2 (L2) UE-to-UE (U2U) relay operation.

FIG. 2a shows a SRAP control PDU used for bearer QoS control in the L2 U2U relay operation according to various exemplary embodiments.

FIG. 2b shows a diagram for transmission of a SRAP control PDU for bearer QoS control in a L2 U2U relay according to various exemplary embodiments.

FIG. 2c shows a SRAP control PDU used for bearer QoS control in the L2 U2U relay operation according to an alternative to the SRAP control PDU described in FIG. 2a.

FIG. 3a shows a SRAP control PDU used for next hop feedback control in the L2 U2U relay operation according to one option.

FIG. 3b shows a SRAP control PDU used for next hop feedback control in the L2 U2U relay operation according to another option.

FIG. 3c shows a diagram for transmission of the SRAP control PDU of FIG. 3a or FIG. 3b for next hop feedback control in a L2 U2U relay according to various exemplary embodiments.

FIG. 4a shows a SRAP control PDU used for delay measurement in the L2 U2U relay operation according to one option.

FIG. 4b shows a SRAP control PDU used for delay measurement in the L2 U2U relay operation according to another option.

FIG. 4c shows a SRAP control PDU used for delay measurement in the L2 U2U relay operation according to still another option.

FIG. 5a shows a SRAP control PDU used for discard status in the L2 U2U relay operation according to one option.

FIG. 5b shows a diagram for transmission of the SRAP control PDU of FIG. 5a for discard status control in a L2 U2U relay according to various exemplary embodiments.

FIG. 6 shows an exemplary network arrangement according to various exemplary embodiments.

FIG. 7 shows an exemplary UE according to various exemplary embodiments.

### DETAILED DESCRIPTION

The exemplary embodiments may be further understood with reference to the following description and the related appended drawings, wherein like elements are provided with the same reference numerals. The exemplary embodiments relate to operations for exchanging control signaling in a layer 2 (L2) UE-to-UE (U2U) relay. In the L2 U2U relay, a relay UE provides relay assistance between two remote UEs. The framework established for the L2 UE-to-network (U2N) relay can be used as a baseline for the design of the L2 U2U relay, including the use of the sidelink (SL) relay adaptation protocol (SRAP) sublayer.

In various aspects described herein, multiple types of SRAP control PDU are described including SRAP control PDUs for bearer quality of service (QoS) control, next hop feedback control, delay measurement, and/or packet discard status. The bearer QoS control PDU can be used to request one of the UEs (remote or relay) to adjust a packet delay budget (PDB) for an end-to-end SL radio bearer (SLRB). The next hop feedback control PDU can be used to provide PDB measurements to a (source) remote UE so that the remote UE can adjust its traffic scheduling to, e.g., prioritize certain traffic or reduce the scheduling latency. The delay measurement control PDU can be used to provide a timestamp for certain events, e.g., packet generation or packet reception, to allow the relay UE to measure the latency of the end-to-end SLRB(s). The timestamp can also be provided in a data PDU. The packet discard status control PDU can be used to indicate a number of data PDUs discarded by the relay UE due to, e.g., radio link failure (RLF) on the link with the (target) remote UE.

The exemplary embodiments are described with regard to a UE. However, the use of a UE is merely provided for illustrative purposes. The exemplary embodiments may be utilized with any electronic component that is configured with the hardware, software, and/or firmware to exchange information (e.g., control information) and/or data with the network. Therefore, the UE as described herein is used to represent any suitable electronic device.

The exemplary embodiments are also described with regard to a sidelink (SL). The term “sidelink” generally refers to a communication link between the UE and a further UE. The SL provides direct device-to-device (D2D) communication where information and/or data exchanged between the UE and the further UE via the sidelink does not go through a cell. In some configurations, a single SL provides bidirectional data communication between the UE and the further UE. In other configurations, a single SL provides unidirectional data communication between the UE and the further UE, although signaling may be transmitted in both directions. The term “unicast” refers to one-to-one, i.e., D2D, communication and generally may refer to either bidirectional or unidirectional communication.

SL communications are supported by both Long-Term Evolution (LTE) and 5G New Radio (NR) standards. In some configurations, the network may provide information to the UE that indicates how an SL is to be established, maintained and/or utilized. Thus, while the information and/or data exchanged over the SL does not go through a cell, the UE and the network may exchange information associated with the SL via the network cell. In other configurations, an SL is not under the control of the network. In either configuration, the first UE and the second UE may still perform synchronization procedures, discovery procedures and exchange control information corresponding to the SL.

In a UE-to-network (U2N) relay, the SL may be used for relay assistance to forward data/signals between a network and a remote UE that is out of range of the network and/or has poor network coverage. For example, a relay UE that is within range of the network and/or has good network coverage may relay data/signals between the network and the remote UE via the SL connection with the remote UE. A Layer 2 (L2) relay forwards received signals to the destination (e.g., remote UE) after successful decoding/encoding and demodulation/modulation of the signals.

The sidelink relay adaptation protocol (SRAP) refers to a sublayer introduced in Rel-17 for the layer 2 (L2) UE-to-network (U2N) relay and is specified in TS 38.351. In the L2 U2N relay, a relay UE provides relay services between the network and a L2 remote UE.

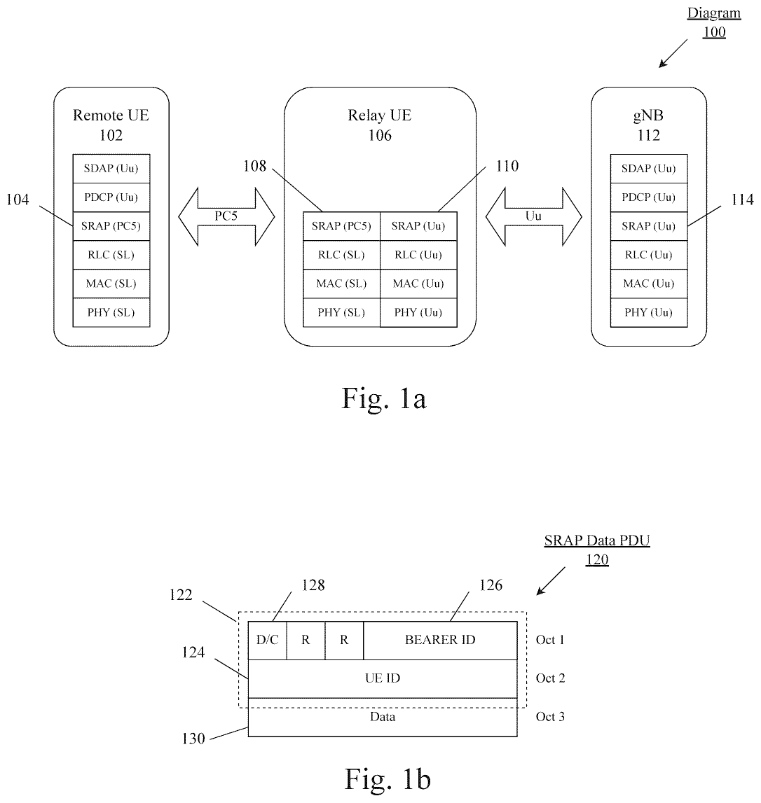

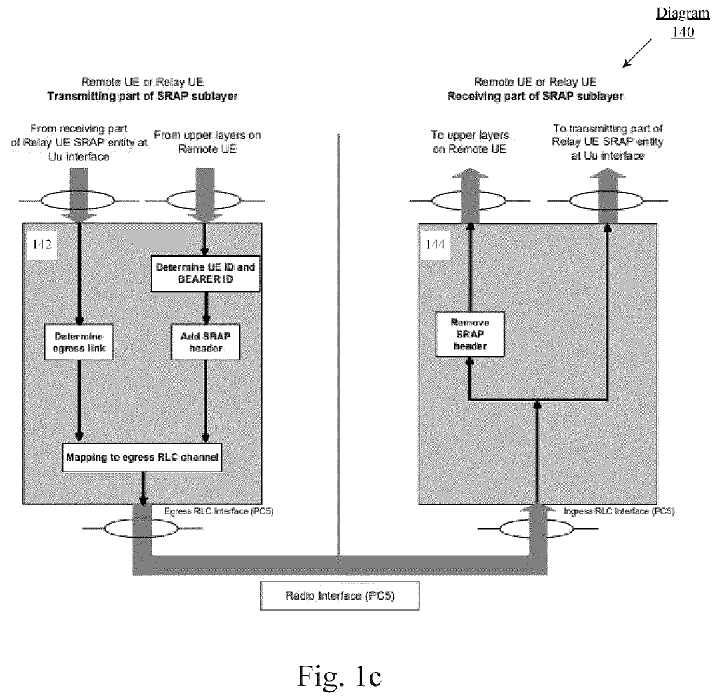

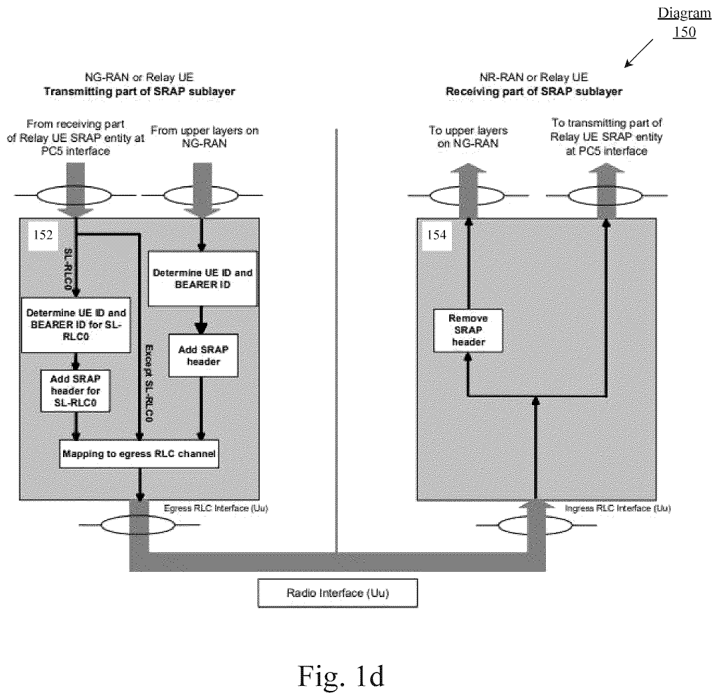

FIG. 1a shows a diagram 100 including protocol layers for a remote UE 102, a relay UE 106 and a gNB 112 in a layer 2 (L2) UE-to-network (U2N) relay operation. On the relay UE 106, the SRAP sublayer contains one SRAP entity 110 at the Uu interface and a separate collocated SRAP entity 108 at the PC5 interface. On the remote UE 102, the SRAP sublayer contains only one SRAP entity 104 at the PC5 interface. On the gNB 112, the SRAP sublayer contains only one SRAP entity 114 at the Uu interface. The SRAP sublayer is located above the radio link control (RLC) layer and below the packet data convergence protocol (PDCP) layer. The PDCP layer performs security and ciphering functions. The packets received at the relay UE are opaque to the relay UE.

Each SRAP entity has a transmitting part and a receiving part. Across the PC5 interface, the transmitting part of the SRAP entity 104 at the remote UE 102 has a corresponding receiving part of an SRAP entity 108 at the relay UE 106, and vice-versa. Across the Uu interface, the transmitting part of the SRAP entity 110 at the relay UE 106 has a corresponding receiving part of the SRAP entity 114 at the gNB 112, and vice-versa.

FIG. 1b shows a SRAP data PDU 120 used in the L2 U2N relay operation. The SRAP data PDU 120 comprises a SRAP header 122 including a UE ID field 124, a bearer ID field 126, a D/C field 128 and two reserved (R) fields. The UE ID field 124 comprises 8 bits and carries a local identity of the remote UE in the L2 U2N relay operation, e.g., the remote UE 102 of FIG. 1a. The local ID is assigned by the network to distinguish amongst remote UEs. The bearer ID field 128 comprises 5 bits and carries a Uu radio bearer identity for the remote UE. The bearer ID is used to differentiate the end-to-end bearers between the same remote UE and network. The D/C field 128 comprises 1 bit and indicates whether the corresponding SRAP PDU is an SRAP data PDU or an SRAP control PDU. In this example, the D/C field 128 is set to “D” (data). It is noted that the SRAP control PDU was not used in Rel-17. The SRAP data PDU 120 further comprises data 130, e.g., the SRAP service data unit (SDU) (received from the PDCP layer, e.g., the PDCP PDU).

The configuration of the SRAP entity for the U2N relay UE includes the local identity for each U2N remote UE, a mapping from the UE ID field and bearer ID field to an egress Uu Relay RLC channel for each U2N remote UE, and a mapping from the UE ID field and bearer ID field to an egress PC5 Relay RLC channel for each U2N remote UE. The SRAP entity is configured via RRC.

FIG. 1c shows a diagram 140 of the SRAP sublayer at the PC5 interface in the L2 U2N relay operation according to one example. The diagram 140 includes a transmitting SRAP entity 142 of the PC5 interface (e.g., in the remote UE or the relay UE) and a receiving PC5 SRAP entity 144 (e.g., in the remote UE or the relay UE). If the transmitting entity 142 is the relay UE, the transmitting entity 142 receives a SRAP PDU from the receiving part of the relay UE SRAP entity at the Uu interface. The transmitting PC5 SRAP entity 142 (in the relay UE) determines an egress link and maps the SRAP PDU to an egress RLC channel (PC5). If the transmitting PC5 SRAP entity 142 is the remote UE, the transmitting entity 142 receives a SRAP SDU from the upper layers (e.g., PDCP). The transmitting PC5 SRAP entity 142 (remote UE) determines the UE ID and bearer ID, adds the SRAP header including the UE ID and the bearer ID to the SRAP SDU (e.g., generates a SRAP PDU), and maps the SRAP PDU to the egress RLC channel (PC5).

The transmitting entity 142 of the PC5 SRAP transmits the SRAP PDU via the egress RLC interface, e.g., PC5. The receiving entity 144 of the PC5 SRAP receives the SRAP PDU via the ingress RLC interface, e.g., PC5. If the receiving entity 144 is the remote UE, the receiving entity 144 processes and removes the SRAP header (generates a SRAP SDU) and transmits the SRAP SDU to the upper layers (e.g., PDCP). If the receiving entity 144 is the relay UE, the receiving entity 144 transmits the SRAP PDU to the transmitting part of the relay UE SRAP entity at the Uu interface.

FIG. 1d shows a diagram 150 of the SRAP sublayer at the Uu interface in the L2 U2N relay operation according to one example. The diagram 150 includes a transmitting Uu SRAP entity 152 (e.g., the RAN/gNB or the relay UE) and a receiving SRAP entity 154 (e.g., the RAN/gNB or the relay UE). If the transmitting Uu SRAP entity 152 is the relay UE, the transmitting entity 152 receives a SRAP PDU from the receiving part of the relay UE SRAP entity at the PC5 interface. If the SRAP PDU indicates SL-RIC0, the transmitting entity 152 (relay UE) determines the UE ID and bearer ID for SL-RLC0, adds the SRAP header including the UE ID and the bearer ID to the SRAP SDU (e.g., generates a SRAP PDU) for SL-RLC0, and maps the SRAP PDU to the egress RLC channel (Uu). If the SRAP PDU does not indicate SL-RLC0, the transmitting entity 152 (in the relay UE) maps the SRAP PDU to the egress RLC channel (Uu). If the transmitting entity 152 is the RAN/gNB, the transmitting entity 152 receives a SRAP SDU from the upper layers (e.g., PDCP). The transmitting entity 152 (in the RAN/gNB) determines the UE ID and bearer ID, adds the SRAP header including the UE ID and the bearer ID to the SRAP SDU (e.g., generates a SRAP PDU), and maps the SRAP PDU to the egress RLC channel (Uu).

The transmitting Uu SRAP entity 152 transmits the SRAP PDU via the egress RLC interface, e.g., Uu. The receiving Uu SRAP entity 154 receives the SRAP PDU via the ingress RLC interface, e.g., Uu. If the receiving entity 154 is the RAN/gNB, the receiving entity 154 processes and removes the SRAP header (generates a SRAP SDU) and transmits the SRAP SDU to the upper layers (e.g., PDCP). If the receiving Uu SRAP entity 154 is in the relay UE, the receiving entity 154 transmits the SRAP PDU to the transmitting part of the relay UE SRAP entity at the PC5 interface.

The L2 UE-to-UE (U2U) relay is to be introduced in Rel-18, wherein a relay UE provides relay services between two remote UEs, e.g., a source remote UE and a target remote UE. In the L2 U2U, it is assumed the SRAP is to be used above the RLC layer, similar to the L2 U2N relay.

FIG. 1e shows a diagram 160 including protocol layers for a source remote UE 162, a relay UE 166 and a target remote UE 170 in a layer 2 (L2) UE-to-UE (U2U) relay operation. On the relay UE 166, the SRAP sublayer contains one SRAP entity 168 at the PC5 interface and a separate RLC entity for each of the two PC5 links (one for each remote UE). On the source remote UE 162, the SRAP sublayer contains one SRAP entity 164 at the PC5 interface. On the target remote UE 170, the SRAP sublayer contains one SRAP entity 172 at the PC5 interface.

The SRAP entity of the relay UE will need to map from fields in the SRAP header of ingress traffic (e.g., from a source remote UE) to the egress PC5 Relay RLC channel for egress towards the target remote UE. The transmission from the source remote UE to the relay UE may be referred to herein as a “first hop” and the transmission from the relay UE to the target remote UE may be referred to herein as a “second hop.” The SRAP header has not yet been designed for L2 U2U operation and requires further specification.

In various aspects of these exemplary embodiments, multiple types of SRAP control PDU are described including SRAP control PDUs for bearer quality of service (QoS) control, next hop feedback control, delay measurement, and/or packet discard status.

In one aspect of these exemplary embodiments, a control PDU in the SRAP layer can be introduced to enhance QoS handling in the L2 U2U relay. The SRAP control PDU for bearer QoS control as described below can be used to request one of the UEs (source remote, target remote, or relay) to adjust a packet delay budget (PDB) for an end-to-end sidelink radio bearer (SLRB) and/or to indicate a preemption flag to prioritize traffic on the bearer. This SRAP control PDU can comprise a field for a packet delay budget parameter and/or a repurposed reserved (R) field for use as a preemption flag.

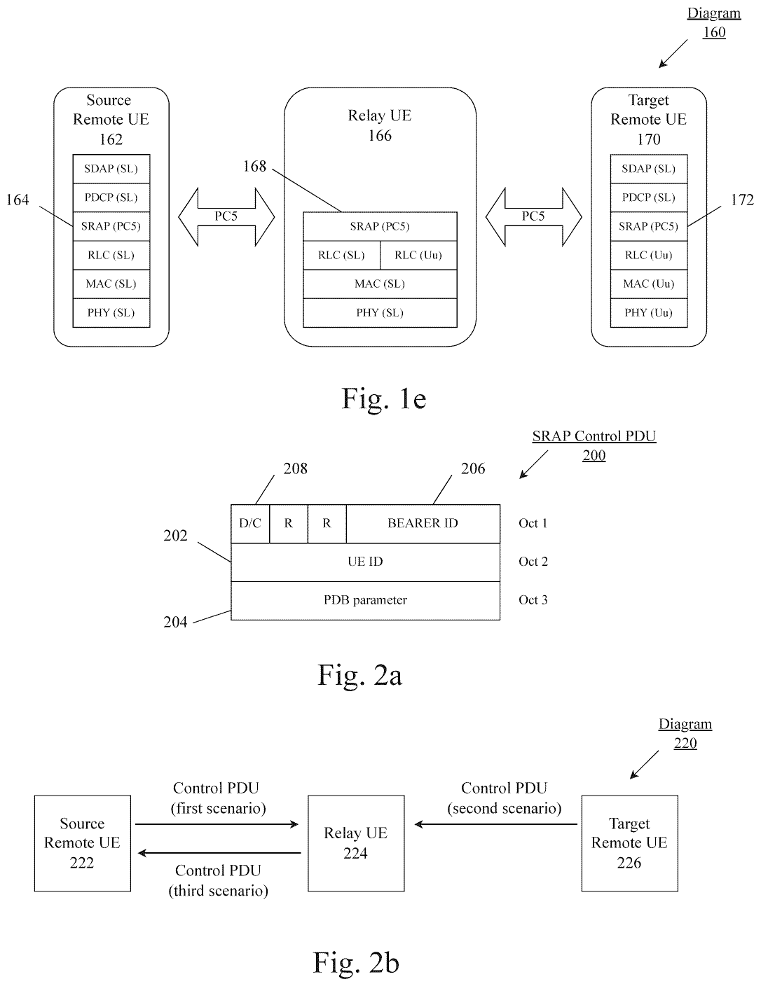

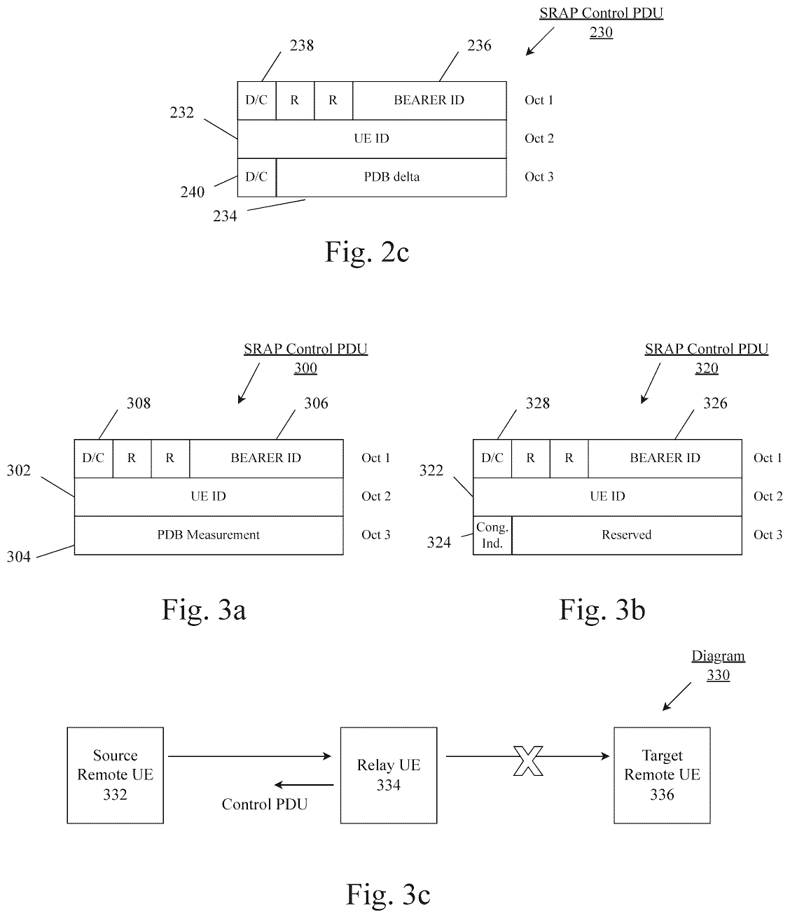

FIG. 2a shows a SRAP control PDU 200 used for bearer QoS control in the L2 U2U relay operation according to various exemplary embodiments. The SRAP control PDU 200 comprises a SRAP header without any data. The SRAP control PDU 200 includes a UE ID field 202 comprising 8 bits that can indicate the identifier of either the source remote UE or the target remote UE. The SRAP control PDU 200 further includes a bearer ID field 206 (5 bits), a D/C field 208 (1 bit) and two reserved (R) fields (1 bit each). The bearer ID field 206 carries a PC5 radio bearer identity for the SL RB between the two remote UEs. The D/C field 208 indicates whether the corresponding SRAP PDU is an SRAP data PDU or an SRAP control PDU. In this example, the D/C field 208 indicates “C” (control). Alternatively, the 8 bit UE ID field can also be a 24-bit L2 ID field, two UE ID fields, or two L2 ID fields to represent both the source remote UE and the target remote UE. Optionally, the Reserved bit(s) can also be replaced with a “type” field to distinguish UN SRAP and U2U SRAP operations and different control PDUs, if multiple different control PDUs are defined. It is noted that, even though there is no control PDU defined for 3GPP Rel-17 for the U2N SRAP operations, it is possible that a control PDU for U2N SRAP operations may be further added in the later releases of standards.

The SRAP control PDU 200 further includes a PDB parameter field 208 comprising 8 bits. The PDB parameter can indicate a PDB value for QoS handling. For example, the PDB can be reduced to reduce the latency for certain traffic.

The SRAP control PDU 200 can be sent by a first UE to a second UE in the U2U relay to adjust the PDB requirements for the traffic of the end-to-end bearer used in the PC5 hop. The control PDU 200 can be used to request the second (receiving) UE to adjust its PDB requirements for transmissions on either the first or second hop, to be described in detail below.

The receiver of the SRAP control PDU (source remote UE, relay UE or target remote UE) will intrinsically know which hop is to be regulated, considering each entity transmits on only one hop. For example, the relay UE can adjust only the second hop for QoS or scheduling purposes, as it is the sender of only the second hop. The relay UE cannot control the scheduling of the first hop. Similarly, the source remote UE can adjust only the first hop for QoS or scheduling purposes, as it is the sender of only the first hop.

FIG. 2b shows a diagram 220 for transmission of a SRAP control PDU for bearer QoS control in a L2 U2U relay according to various exemplary embodiments. The diagram 220 includes a source remote UE 222, a relay UE 224 and a target remote UE 226.

In a first scenario, the source remote UE 222 transmits the SRAP control PDU 200 to the relay UE 224 to request the relay UE 224 to adjust the PDB for the second hop (e.g., relay data transmission to the target remote UE 226) for an end-to-end SLRB.

In a second scenario, the relay UE 224 transmits the SRAP control PDU to the source remote UE 222 to request the source remote UE 222 to adjust the PDB used in the SL scheduling for the first hop.

In a third scenario, the target remote UE 226 transmits the SRAP control PDU to the relay UE 224 to request the relay UE 224 to adjust the PDB for the second hop.

The SRAP control PDU for bearer QoS control is suitable for short-term adjustment when there is no need to change PC5 RLC bearer configuration. This control PDU is also useful for scenarios where multiple end-to-end bearers with slightly different latency requirements are multiplexed to the same PC5 Relay RLC channel.

In an alternative embodiment, the SRAP control PDU for bearer QoS control can include a PDB parameter field that indicates a delta adjustment and a separate I/D field for indicating whether the delta indication should increase or decrease the PDB, where if this field indicates “I”, then it means increasing (relaxing) the PDB requirements, while “D” means decreasing (tightening) the PDB requirements.

FIG. 2c shows a SRAP control PDU 230 used for bearer QoS control in the L2 U2U relay operation according to an alternative to the SRAP control PDU 200 described in FIG. 2a. Similar to the SRAP control PDU 200 of FIG. 2a, the SRAP control PDU 230 includes a UE ID field 232 comprising 8 bits that can indicate the identifier of either the source remote UE or the target remote UE. The SRAP header 230 further includes a bearer ID field 236 (5 bits), a D/C field 238 (1 bit) indicating “C” (control), and two reserved (R) fields (1 bit each).

Relative to the SRAP control PDU 200 of FIG. 2a, the SRAP control PDU 230 of FIG. 2c includes a PDB delta field 234 comprising 7 bits and a I/D field 440 comprising 1 bit. The PDB delta field 234 carries 1 bit less information than the PDB parameter field 204 of FIG. 2a, however, the I/D field 240 provides further information regarding the direction of the adjustment (relaxing or tightening).

The SRAP control PDUs 200, 230 described above include two reserved (R) fields. One of these R fields can be repurposed to carry a preemption flag. The preemption flag is used to request the UE to put the traffic at the head of the first-in-first-out (FIFO) queueing in scheduling, among all the packets in the same PC5 RLC channel awaiting transmission/forwarding. In other words, the preemption flag indicates a prioritization of certain ingress traffic on the egress PC5 RLC channel, where the prioritized ingress traffic is indicated in the bearer ID and UE ID field(s).

In another aspect of these exemplary embodiments, a control PDU in the SRAP layer can be introduced to indicate a next hop status in the L2 U2U relay. In some embodiments, the next hop feedback control PDU can be used by the relay UE to provide PDB measurements to a (source) remote UE so that the remote UE can adjust its traffic scheduling to, e.g., prioritize certain traffic or reduce the scheduling latency. In other embodiments, the SRAP control PDU for next hop feedback control can be used by the relay UE to indicate to the source remote UE that congestion is occurring on the second hop. This SRAP control PDU can comprise a field for a PDB measurement and/or a field for congestion indication.

FIG. 3a shows a SRAP control PDU 300 used for next hop feedback control in the L2 U2U relay operation according to one option. Similar to the SRAP control PDU 200 of FIG. 2a, the SRAP control PDU 300 of FIG. 3a comprises a SRAP header without any data and includes a UE ID field 302 (8 bits), a bearer ID field 306 (5 bits), a D/C field 308 (1 bit) indicating “C” (control), and two reserved (R) fields (1 bit each).

The SRAP control PDU 300 further includes a PDB measurement field 304 comprising 8 bits. The PDB measurement can indicate the performance for the delivery of end-to-end SLRB on the second PC5 hop.

The SRAP control PDU 300 can be sent by the relay UE to the source remote UE in the U2U relay to inform the source remote UE regarding decisions with respect to scheduling, e.g., prioritizing the traffic in scheduling or reduce the scheduling latency.

The SRAP Control PDU can also be used as a congestion indicator. For example, if the relay UE is experiencing congestion on the second hop, the relay UE can transmit the SRAP control PDU to the source remote UE to inform the source remote UE regarding decisions with respect to scheduling, e.g., prioritizing the traffic in scheduling, similar to the PDB measurement.

FIG. 3b shows a SRAP control PDU 320 used for next hop feedback control in the L2 U2U relay operation according to another option. Similar to the SRAP control PDU 300 of FIG. 3a, the SRAP control PDU 320 of FIG. 3b comprises a SRAP header without any data and includes a UE ID field 322 (8 bits), a bearer ID field 326 (5 bits), a D/C field 328 (1 bit) indicating “C”(control), and two reserved (R) fields (1 bit each). Alternatively, similar to above, the UE ID field can also be a 24-bit L2 ID, two UE ID fields, or two L2 ID fields to represent both the source Remote UE and the target Remote UE. In one of the alternative embodiments, the “reserved” bit/field can be replaced with a one-bit or two-bit “type” field to distinguish U2N SRAP and U2U SRAP operations or different types of control PDUS.

Relative to the SRAP control PDU 300 of FIG. 3a, the SRAP control PDU 320 of FIG. 3b includes a congestion indication field 324 comprising 1 bit. The congestion indication field 324 indicates whether there is congestion on the second hop or not.

FIG. 3c shows a diagram 330 for transmission of the SRAP control PDU of FIG. 3a or FIG. 3b for next hop feedback control in a L2 U2U relay according to various exemplary embodiments. The diagram 330 includes a source remote UE 332, a relay UE 334 and a target remote UE 336.

The relay UE 334 can generate PDB measurements or determine that congestion exists on the second hop to the target remote UE 336. The relay UE 334 can transmit the SRAP control PDU for feedback control (e.g., SRAP control PDU 300 or 320) to the source remote UE. Based on the PDB measurements and/or the congestion indication, the source remote UE can adjust its scheduling to alleviate the congestion.

Both the bearer QoS control PDU and the feedback control PDU can be designated for a particular end-to-end bearer represented by the bearer ID. Alternatively, a new (unused) Bearer ID (special value) can represent that the control PDU is applicable to all the E2E bearers.

In another aspect of these exemplary embodiments, a control PDU in the SRAP layer can be introduced to indicate one or more timestamps for a delay measurement in the L2 U2U relay. The SRAP control PDU for delay measurement can be used to allow the relay UE or the target remote UE to measure the overall latency or per-hop latency for certain E2E bearers. The delay measurement control PDU can be used to provide a timestamp for certain events, e.g., packet generation or packet reception, to allow the relay/remote UE to measure the latency of the end-to-end SLRB(s). The timestamp(s) can also be provided in a data PDU. The relay UE can use one or more timestamps to calibrate the forwarding scheduling to avoid exceeding the overall latency budget. This SRAP control PDU can comprise a field for each timestamp that is inserted, e.g., one, two or three. Based on the delay measurement determined from the timestamps, the target remote UE or the relay UE can provide feedback to an upstream UE that can be used by the upstream UE for scheduling purposes.

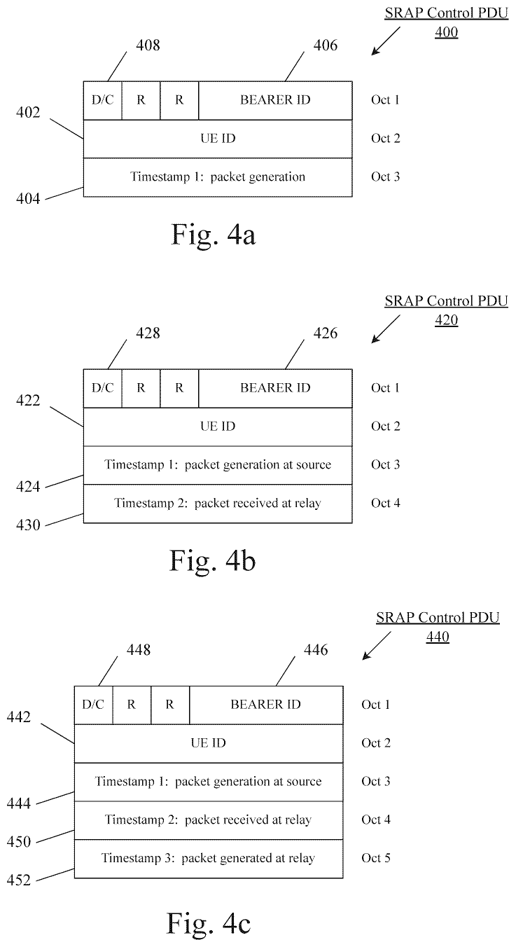

FIG. 4a shows a SRAP control PDU 400 used for delay measurement in the L2 U2U relay operation according to one option. Similar to the previous aspects, the SRAP control PDU 400 comprises a SRAP header without any data and includes a UE ID field 402 (8 bits), a bearer ID field 406 (5 bits), a D/C field 408 (1 bit) indicating “C” (control), and two reserved (R) fields (1 bit each).

The SRAP control PDU 400 further includes a single timestamp field 404 comprising 8 bits. The timestamp field 404 can indicate the time at which the SRAP PDU was generated. In this embodiment, the single timestamp can be inserted by the source remote UE or the relay UE.

The single timestamp can be used by the relay UE to determine the delay between a PDU generation at the source remote UE and the arrival of the PDU at the relay UE. The single timestamp can also be used by the target remote UE to determine the delay between a PDU generation at the relay UE and the arrival of the PDU at the target remote UE.

FIG. 4b shows a SRAP control PDU 420 used for delay measurement in the L2 U2U relay operation according to another option. Similar to the previous aspects, the SRAP control PDU 420 comprises a SRAP header without any data and includes a UE ID field 422 (8 bits), a bearer ID field 426 (5 bits), a D/C field 428 (1 bit) indicating “C” (control), and two reserved (R) fields (1 bit each). Similar to the SRAP control PDU 400 of FIG. 4a, the SRAP control PDU 420 comprises a (first) timestamp field 424 for the packet generation at the source remote UE.

Relative to the SRAP control PDU 400 of FIG. 4a, the SRAP control PDU 420 of FIG. 4b also includes an additional (second) timestamp field 430 also comprising 8 bits. The second timestamp field 430 can indicate the time at which the SRAP PDU was received at the relay UE. In this embodiment, the first timestamp is inserted by the source remote UE and the second timestamp is inserted by the relay UE.

The second timestamp can be used by the remote UE to determine the delay between the packet generation at the source remote UE and the arrival of the packet at the relay UE.

FIG. 4c shows a SRAP control PDU 440 used for delay measurement in the L2 U2U relay operation according to still another option. Similar to the previous aspects, the SRAP control PDU 440 comprises a SRAP header without any data and includes a UE ID field 442 (8 bits), a bearer ID field 446 (5 bits), a D/C field 448 (1 bit) indicating “C” (control), and two reserved (R) fields (1 bit each). Similar to the SRAP control PDU 420 of FIG. 4b, the SRAP control PDU 440 comprises a first timestamp field 444 for the packet generation at the source remote UE and a second timestamp field 650 for the packet received at the relay UE.

Relative to the SRAP control PDU 420 of FIG. 4b, the SRAP control PDU 440 of FIG. 4c also includes an additional (third) timestamp field 442 also comprising 8 bits. The third timestamp field 442 can indicate the time at which the SRAP PDU was generated at the relay UE.

The third timestamp can be used by the target remote UE to determine the delay between the packet generation at the relay UE and the arrival of the packet at the target remote UE.

Based on these one or more timestamps, and in view of further transmissions received from the target remote UE (e.g., feedback), the relay UE or remote UE (s) can measure the overall latency or per-hop latency for certain end to end bearers. Note that this measurement is done for this control PDU without data. Alternatively, this can also be done in the SRAP Data PDU where data is also piggybacked. In this case, the type field in SRAP header needs to further indicate that the data is piggybacked.

In still another aspect of these exemplary embodiments, a control PDU in the SRAP layer can be introduced to indicate a number of discarded packets to inform traffic loss (discard status) between the remote UE and the relay UE regarding the end-to-end SLRB in the L2 U2U relay. In some embodiments, the SRAP control PDU for discard status can be used by the relay UE to inform the source UE of discarded PDUs so that the source UE can prepare for the loss. The packet discard status control PDU can be used to indicate a number of data PDUs discarded by the relay UE due to, e.g., radio link failure (RLF) on the link with the (target) remote UE.

The relay UE can indicate the number of SRAP PDUs buffered in the relay UE but unable to be delivered to the next hop (target remote UE) . This SRAP control PDU can comprise a field for a number of discarded packets. Those PDUs may be discarded due to, e.g., PC5 RIF (between the relay UE and the target remote UE). The source remote UE may want to know how many packets are discarded so that timely preparations can be made for the loss. This control PDU can be used as an alternative to end-to-end PDCP status report for reporting traffic delivery problems. Compared to the PDCP status report, this SRAP control PDU can provide a much faster alert to the source remote UE about potential packet loss. It is noted that multiple SRAP control PDUs could be generated by the relay UE for different end-to-end bearers.

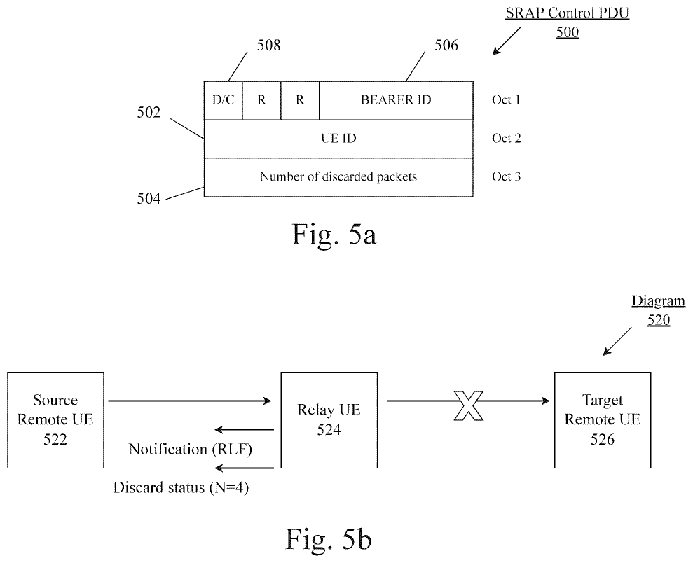

FIG. 5a shows a SRAP control PDU 500 used for discard status in the L2 U2U relay operation according to one option. Similar to the previous aspects, the SRAP control PDU 500 comprises a SRAP header without any data and includes a UE ID field 502 (8 bits), a bearer ID field 506 (5 bits), a D/C field 508 (1 bit) indicating “C” (control), and two reserved (R) fields (1 bit each). In a related embodiment, the “reserved” bit/field(s) can be replaced with a one-bit or two-bit “type” field to distinguish U2N SRAP and U2U SRAP operations.

The SRAP control PDU 500 further includes a number of discarded packets field 504 comprising 8 bits. The packets may be discarded due to, e.g., RIF on the second hop.

FIG. 5b shows a diagram 520 for transmission of the SRAP control PDU 500 of FIG. 5a for discard status control in a L2 U2U relay according to various exemplary embodiments. The diagram 520 includes a source remote UE 522, a relay UE 524 and a target remote UE 526.

The relay UE 524 can determine that RLF has occurred on the second hop and notify the source remote UE 522. The relay UE 524 can further generate a discard status for the second hop to the target remote UE 526. In this example, the relay UE 524 has discarded four packets for the second hop. The relay UE 524 can transmit the SRAP control PDU for discard status (e.g., SRAP control PDU 500) to the source remote UE. Based on the number of discarded packets, the source remote UE can prepare for the lost packets.

It is noted that, rather than repurposing a reserved field/bit to indicate a “type,” a new 8-bit (one octet) “type” field can be introduced to distinguish between U2U and U2N operation and further to indicate different control PDU types, if multiple control PDU types are adopted.

As described above, a SRAP control PDU or a SRAP data PDU can be used at various times to request a change in operation or provide information about the U2U relay. The control PDU can be sent from the source remote UE to the relay UE to request an adjustment to the PDB requirements on the second hop or to indicate a timestamp at which the control PDU was generated at the source remote UE. The control PDU can be sent from the relay UE to the source remote UE to request an adjustment to the PDB requirements on the first hop, to indicate a PDB measurement or congestion on the second hop, or to indicate a number discarded packets. The control PDU can be sent from the relay UE to the target remote UE to indicate one or more timestamps, e.g., the times at which the control PDU was generated at the source remote UE, received at the relay UE, and/or generated at the relay UE. The control PDU can be sent from the target remote UE to the relay UE to request an adjustment to the PDB requirements on the second hop. The timestamps can also be transmitted in an SRAP data PDU.

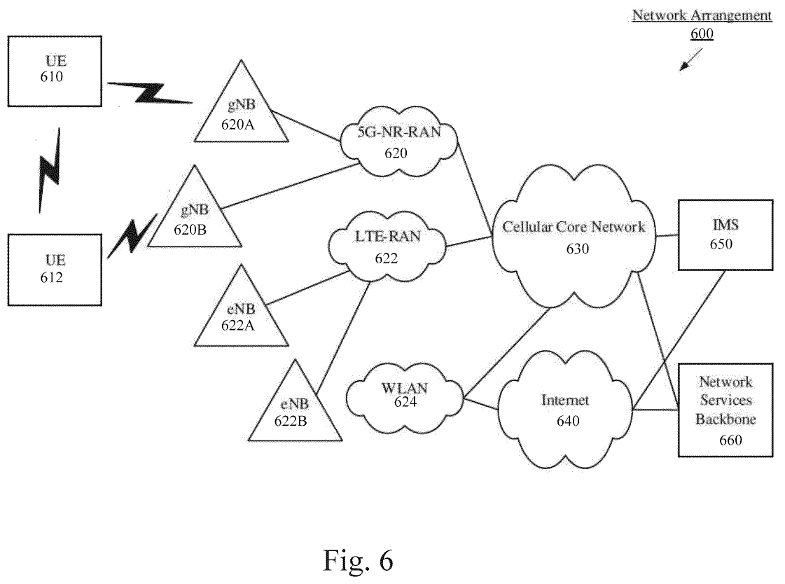

FIG. 6 shows an exemplary network arrangement 600 according to various exemplary embodiments. The exemplary network arrangement 600 include UEs 610, 612. Those skilled in the art will understand that the UEs 610, 612 may be any type of electronic component that is configured to communicate via a network, e.g. mobile phones, tablet computers, desktop computers, smartphones, phablets, embedded devices, wearables (e.g., HMD, AR glasses, etc.), Internet of Things (IoT) devices, etc. It should also be understood that an actual network arrangement may include any number of UEs being used by any number of users. Thus, the example of two UEs 610, 612 is merely provided for illustrative purposes.

The UEs 610, 612 may communicate directly with one or more networks. In the example of the network configuration 600, the networks with which the UEs 610, 612 may wirelessly communicate are a 5G NR radio access network (5G NR-RAN) 620, an LTE radio access network (LTE-RAN) 622 and a wireless local access network (WLAN) 624. These types of networks support sidelink (SL) communication. In the exemplary network arrangement 600, the UEs 610 and 612 may be connected via a SL. However, the UEs 610, 612 may also communicate with other types of networks and the UEs 610, 612 may also communicate with networks over a wired connection. Therefore, the UEs 610, 612 may include a 5G NR chipset to communicate with the 5G NR-RAN 620, an ITE chipset to communicate with the LTE-RAN 622 and an ISM chipset to communicate with the WLAN 624.

The 5G NR-RAN 620 and the LTE-RAN 622 may be portions of cellular networks that may be deployed by a network carrier (e.g., Verizon, AT&T, T-Mobile, etc.). These networks 620, 622 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 624 may include any type of wireless local area network (WiFi, Hot Spot, IEEE 802.11x networks, etc.).

The UEs 610, 612 may connect to the 5G NR-RAN via the gNB 620A or the gNB 620B. Reference to two gNBs 620A, 620B is merely for illustrative purposes. The exemplary embodiments may apply to any appropriate number of gNBs. The UEs 610, 612 may also connect to the LTE-RAN 622 via the eNBs 622A, 622B. Those skilled in the art will understand that any association procedure may be performed for the UEs 610, 612 to connect to the 5G NR-RAN 620 and the LTE-RAN 622. For example, as discussed above, the 5G NR-RAN 620 and the LTE-RAN 622 may be associated with a particular cellular provider where the UEs 610, 612 and/or the user thereof has a contract and credential information (e.g., stored on a SIM card). Upon detecting the presence of the 5G NR-RAN 620, the UEs 610, 612 may transmit the corresponding credential information to associate with the 5G NR-RAN 620. More specifically, the UEs 610, 612 may associate with a specific base station (e.g., the gNB 620A of the 5G NR-RAN 620, the eNB 622A of the LTE-RAN 622).

The UEs 610, 612 may also communicate with one another directly using a SL. The SL is a direct device-to-device (D2D) communication link. Thus, the information and/or data transmitted directly to the other endpoint (e.g., the UE 610 or the UE 612) does not go through a cell (e.g., gNB 620A, eNB 622A). In some embodiments the UEs 610, 612 may receive information from a cell regarding how the SL is to be established, maintained and/or utilized. Thus, a network (e.g., the 5G NR-RAN 620, LTE-RAN 622) may control the SL. In other embodiments, the UEs 610, 612 may control the SL. Regardless of how the SL is controlled, the UEs 610, 612 may maintain a downlink/uplink to a currently camped cell (e.g., gNB 620A, eNB 622A) and a SL to the other UE simultaneously.

In some scenarios, a UE, e.g., the UE 610, may not have a direct connection with a cell and may use a further UE, e.g., the UE 612, as a relay UE to forward data/signals to/from the UE 610 and/or the 5G NR-RAN 620. The SL may be used for relay assistance to forward data/signals between the 5G NR-RAN 620 and the remote UE 610 that is out of range of the network and/or has poor network coverage. A Layer 2 (L2) UE to network (U2N) relay amplifies received signals to the destination after successful decoding/encoding and demodulation/modulation of the signals.

In some other scenarios, a UE, e.g., the UE 610, may use a relay UE to forward data/signals to/from another remote UE in a L2 U2U relay.

In addition to the networks 620, 622 and 624 the network arrangement 600 also includes a cellular core network 630, the Internet 640, an IP Multimedia Subsystem (IMS) 650, and a network services backbone 660. The cellular core network 630 may be considered to be the interconnected set of components that manages the operation and traffic of the cellular network. The cellular core network 630 also manages the traffic that flows between the cellular network and the Internet 640. The IMS 650 may be generally described as an architecture for delivering multimedia services to the UEs 610, 612 using the IP protocol. The IMS 650 may communicate with the cellular core network 630 and the Internet 640 to provide the multimedia services to the UEs 610, 612. The network services backbone 660 is in communication either directly or indirectly with the Internet 640 and the cellular core network 630. The network services backbone 660 may be generally described as a set of components (e.g., servers, network storage arrangements, etc.) that implement a suite of services that may be used to extend the functionalities of the UEs 610, 612 in communication with the various networks.

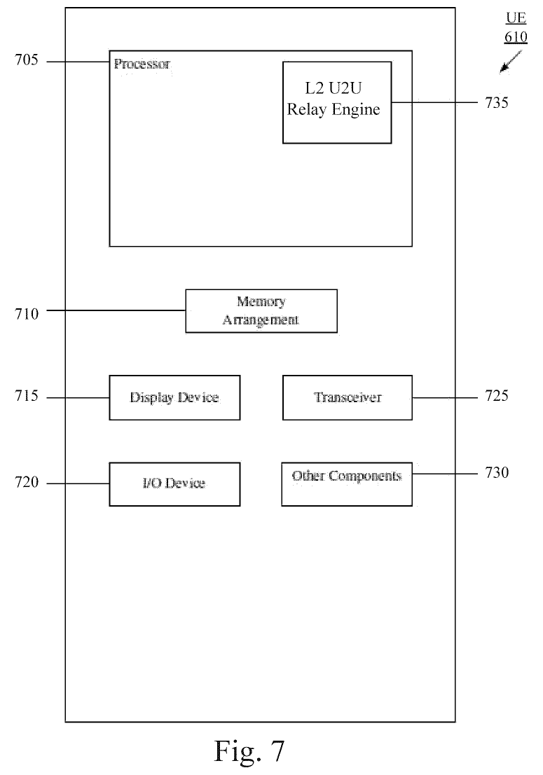

FIG. 7 shows an exemplary UE 610 according to various exemplary embodiments. The UE 610 will be described with regard to the network arrangement 600 of FIG. 6. The UE 610 may include a processor 705, a memory arrangement 710, a display device 715, an input/output (I/O) device 720, a transceiver 725 and other components 730. The other components 730 may include, for example, an audio input device, an audio output device, a power supply, a data acquisition device, ports to electrically connect the UE 610 to other electronic devices, etc.

The processor 705 may be configured to execute a plurality of engines of the UE 610. For example, the engines may include an L2 U2U relay engine 735 for performing various operations related to establishing the L2 U2U relay and transmitting/receiving SRAP data PDUs and/or SRAP control PDUs for a source remote UE, a relay UE, or a target remote UE, as described above.

The above referenced engine 735 being an application (e.g., a program) executed by the processor 705 is provided merely for illustrative purposes. The functionality associated with the engine 735 may also be represented as a separate incorporated component of the UE 610 or may be a modular component coupled to the UE 610, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 705 is split among two or more processors such as a baseband processor and an applications processor, The exemplary embodiments may be implemented in any of these or other configurations of a UE.

The memory arrangement 710 may be a hardware component configured to store data related to operations performed by the UE 610. The display device 715 may be a hardware component configured to show data to a user while the I/O device 720 may be a hardware component that enables the user to enter inputs. The display device 715 and the I/O device 720 may be separate components or integrated together such as a touchscreen. The transceiver 725 may be a hardware component configured to establish a connection with the 5G NR-RAN 620 and/or any other appropriate type of network. Accordingly, the transceiver 725 may operate on a variety of different frequencies or channels (e.g., set of consecutive frequencies).

### EXAMPLES

In a first example, a processor of a user equipment (UE) configured to perform operations comprising establishing a layer 2 (L2) UE-to-UE (U2U) relay operation with a source remote UE and a target remote UE wherein the UE is a relay UE, wherein the source remote UE and the relay UE communicate via a first sidelink (SL) and wherein the relay UE and the target remote UE communicate via a second SL, generating a SL relay adaptation protocol (SRAP) protocol data unit (PDU) including a SRAP header comprising an identifier for at least the source remote UE, wherein the SRAP header indicates a request, provides a measurement or provides a status with respect to the first or second SL and transmitting the SRAP PDU to the target remote UE on the second SL or the source remote UE on the first SL.

In a second example, the processor of first example, wherein the SRAP PDU comprises only the SRAP header and is a SRAP control PDU.

In a third example, the processor of second example, wherein the SRAP control PDU is for bearer quality of service (QoS) control and indicates a preemption flag requesting the source remote UE to prioritize associated traffic in a same end-to-end SI radio bearer.

In a fourth example, the processor of second example, wherein the SRAP control PDU is for delay measurement and indicates a first timestamp for a time at which a received SRAP control PDU was generated at the source remote UE, wherein the SRAP control PDU is transmitted to the target remote UE.

In a fifth example, the processor of fourth example, wherein the SRAP control PDU further indicates a second timestamp for a time at which the received SRAP control PDU was received at the relay UE.

In a sixth example, the processor of fifth example, wherein the SRAP control PDU further indicates a third timestamp for a time at which the SRAP control PDU was generated at the relay UE.

In a seventh example, the processor of second example, wherein the SRAP control PDU indicates a special value for a bearer ID indicating the SRAP control PDU is applicable to all end-to-end SL radio bearers.

In an eighth example, the processor of second example, wherein the SRAP control PDU is for bearer quality of service (QoS) control and indicates a request to the source remote UE to adjust a packet delay budget (PDB) for the first SL between the source remote UE and the relay UE for an end-to-end SL radio bearer.

In a ninth example, the processor of second example, wherein the SRAP control PDU is for bearer quality of service (QoS) control and indicates a preemption flag requesting the source remote UE to prioritize associated traffic for the first SL between the source remote UE and the relay UE in a same end-to-end SI radio bearer.

In a tenth example, the processor of second example, wherein the SRAP control PDU is for feedback control and indicates to the source remote UE a packet delay budget (PDB) measurement for the second SL between the relay UE and the target remote UE for an end-to-end SL radio bearer.

In an eleventh example, the processor of second example, wherein the SRAP control PDU is for feedback control and indicates to the source remote UE whether the second SL between the relay UE and the target remote UE for an end-to-end SL radio bearer is congested.

In a twelfth example, the processor of second example, wherein the SRAP control PDU is for discard status and indicates to the source remote VE a number of packets discarded for the second SL between the relay UE and the target remote UE.

In a thirteenth example, the processor of first example, wherein the SRAP PDU comprises data and is a SRAP data PDU, wherein the SRAP data PDU includes the SRAP header for delay measurement and indicates a timestamp for a time at which a received SRAP data PDU was generated at the source remote UE, a time at which the received SRAP control PDU was received at the relay UE, or a time at which the SRAP control PDU was generated at the relay UE, wherein the SRAP control PDU is transmitted to the target remote UE.

In a fourteenth example, the processor of first example, wherein the SRAP header further includes a bearer ID field to indicate an end-to-end SL bearer between the source remote UE and the target remote UE.

In a fifteenth example, the processor of first example, wherein the SRAP header further includes a type field to indicate that the identifier of at least the target remote UE is used for the U2U relay operation rather than a UE-to-network (U2N) relay operation or to distinguish among multiple types of SRAP control PDU.

In a sixteenth example, a processor of a user equipment (UE) configured to perform operations comprising establishing a layer 2 (L2) UE-to-UE (U2U) relay operation with a source remote UE and a relay UE wherein the UE is a target remote UE, wherein the source remote UE and the relay UE communicate via a first sidelink (SL) and wherein the relay UE and the target remote UE communicate via a second SL and receiving a SL relay adaptation protocol (SRAP) protocol data unit (PDU) on the second SL including a SRAP header comprising an identifier for at least the source remote UE, wherein the SRAP header indicates a request or provides a measurement with respect to the first or second SI.

In a seventeenth example, the processor of the sixteenth example, wherein the SRAP PDU comprises only the SRAP header and is a SRAP control PDU.

In an eighteenth example, the processor of the seventeenth example, wherein the SRAP control PDU is for delay measurement and indicates a first timestamp for a time at which a first SRAP control PDU was generated at the source remote UE.

In a nineteenth example, the processor of the eighteenth example, wherein the SRAP control PDU further indicates a second timestamp for a time at which the first SRAP control PDU was received at the relay UE.

In an twentieth example, the processor of the nineteenth example, wherein the SRAP control PDU further indicates a third timestamp for a time at which the SRAP control PDU was generated at the relay UE.

In a twenty first example, the processor of the eighteenth example, wherein the operations further comprise transmitting a SRAP control PDU for bearer quality of service (QoS) control indicating a request to the relay UE to adjust a packet delay budget (PDB) for the second SL between the relay UE and the target remote UE for an end-to-end SI radio bearer.

In a twenty second example, the processor of the twenty first example, wherein the SRAP control PDU includes a PDB parameter indicating an adjustment of the PDB.

In a twenty third example, the processor of the twenty first example, wherein the SRAP control PDU includes a PDB parameter indicating a delta adjustment of the PDB and a further parameter indicating whether the delta adjustment is positive or negative.

In a twenty fourth example, the processor of the seventeenth example, wherein the operations further comprise transmitting a SRAP control PDU for bearer quality of service (QoS) control indicating a preemption flag requesting the relay UE to prioritize associated traffic in a same end-to-end SL radio bearer.

In a twenty fifth example, the processor of the seventeenth example, wherein the operations further comprise transmitting a SRAP control PDU indicating a special value for a bearer ID indicating the SRAP control PDU is applicable to all end-to-end SL radio bearers.

In a twenty sixth example, the processor of the seventeenth example, wherein the SRAP PDU comprises data and is a SRAP data PDU, wherein the SRAP data PDU includes the SRAP header for delay measurement and indicates a timestamp for a time at which a received SRAP data PDU was generated at the source remote UE, a time at which the received SRAP control PDU was received at the relay UE, or a time at which the SRAP control PDU was generated at the relay UE, wherein the SRAP control PDU is transmitted to the target remote UE.

In a twenty seventh example, the processor of the seventeenth example, wherein the SRAP header further includes a bearer ID field to indicate an end-to-end SL bearer between the source remote UE and the target remote UE.

In a twenty eighth example, the processor of the seventeenth example, wherein the SRAP header further includes a type field to indicate that the identifier of at least the target remote UE is used for the U2U relay operation rather than a UE-to-network (U2N) relay operation or to distinguish among multiple types of SRAP control PDU.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

1. A processor of a user equipment (UE) configured to perform operations comprising:
establishing a layer 2 (L2) UE-to-UE (U2U) relay operation with a relay UE and a target remote UE wherein the UE is a source remote UE, wherein the source remote UE and the relay UE communicate via a first sidelink (SL) and wherein the relay UE and the target remote UE communicate via a second SL;
generating a SL relay adaptation protocol (SRAP) protocol data unit (PDU) including a SRAP header comprising an identifier for at least the target remote UE, wherein the SRAP header indicates a request, provides a measurement or provides a status with respect to the first or second SL; and
transmitting the SRAP PDU to the relay UE on the first SL.

2. The processor of claim 1, wherein the SRAP PDU comprises only the SRAP header and is a SRAP control PDU.

3. The processor of claim 2, wherein the SRAP control PDU is for bearer quality of service (QoS) control and indicates a request to the relay UE to adjust a packet delay budget (PDB) for the second SL between the relay UE and the target remote UE for an end-to-end SL radio bearer.

4. The processor of claim 3, wherein the SRAP control PDU includes a PDB parameter indicating an adjustment of the PDB.

5. The processor of claim 3, wherein the SRAP control PDU includes a PDB parameter indicating a delta adjustment of the PDB and a further parameter indicating whether the delta adjustment is positive or negative.

6. The processor of claim 2, wherein the SRAP control PDU is for bearer quality of service (QoS) control and indicates a preemption flag requesting the relay UE to prioritize associated traffic in a same end-to-end SL radio bearer.

7. The processor of claim 2, wherein the SRAP control PDU is for delay measurement and indicates a timestamp for a time at which the SRAP control PDU was generated.

8. The processor of claim 2, wherein the SRAP control PDU indicates a special value for a bearer ID indicating the SRAP control PDU is applicable to all end-to-end SL radio bearers.

9. The processor of claim 1, wherein the operations further comprise:
receiving an SRAP control PDU for bearer quality of service (QoS) control from the relay UE indicating a request to the source remote UE to adjust a packet delay budget (PDB) for the first SL between the source remote UE and the relay UE for an end-to-end SL radio bearer; and
adjusting the PDB for the first SL based on the request.

10. The processor of claim 1, wherein the operations further comprise:
receiving an SRAP control PDU for bearer quality of service (QoS) control from the relay UE indicating a preemption flag requesting the source remote UE to prioritize associated traffic for the first SL between the source remote UE and the relay UE in a same end-to-end SL radio bearer; and
prioritizing the associated traffic.

11. The processor of claim 1, wherein the operations further comprise:
receiving an SRAP control PDU for feedback control indicating a packet delay budget (PDB) measurement for the second SL between the relay UE and the target remote UE for an end-to-end SL radio bearer; and
adjusting scheduling for the first SL based on the PDB measurement.

12. The processor of claim 1, wherein the operations further comprise:
receiving an SRAP control PDU for feedback control indicating whether the second SL between the relay UE and the target remote UE for an end-to-end SL radio bearer is congested; and
adjusting scheduling for the first SL based on whether the second SL is congested.

13. The processor of claim 1, wherein the operations further comprise:
receiving an SRAP control PDU for discard status indicating a number of packets discarded for the second SL between the relay UE and the target remote UE.

14. The processor of claim 1, wherein the SRAP PDU comprises data and is a SRAP data PDU, wherein the SRAP data PDU includes the SRAP header for delay measurement and indicates a timestamp for a time at which the SRAP data PDU was generated.

15. The processor of claim 1, wherein the SRAP header further includes a bearer ID field to indicate an end-to-end SL bearer between the source remote UE and the target remote UE.

16. The processor of claim 1, wherein the SRAP header further includes a type field to indicate that the identifier of at least the target remote UE is used for the U2U relay operation rather than a UE-to-network (U2N) relay operation or to distinguish among multiple types of SRAP control PDU.

17. A processor of a user equipment (UE) configured to perform operations comprising:
establishing a layer 2 (L2) UE-to-UE (U2U) relay operation with a source remote UE and a target remote UE wherein the UE is a relay UE, wherein the source remote UE and the relay UE communicate via a first sidelink (SL) and wherein the relay UE and the target remote UE communicate via a second SL;
generating a SL relay adaptation protocol (SRAP) protocol data unit (PDU) including a SRAP header comprising an identifier for at least the source remote UE, wherein the SRAP header indicates a request, provides a measurement or provides a status with respect to the first or second SL; and
transmitting the SRAP PDU to the target remote UE on the second SL or the source remote UE on the first SL.

18. The processor of claim 17, wherein the SRAP PDU comprises only the SRAP header and is a SRAP control PDU.

19. The processor of claim 18, wherein the SRAP control PDU is for bearer quality of service (QoS) control and indicates a request to the source remote UE to adjust a packet delay budget (PDB) for the first SL between the source remote UE and the relay UE for an end-to-end SL radio bearer.

20. The processor of claim 19, wherein the SRAP control PDU includes a PDB parameter indicating an adjustment of the PDB.

21. (canceled)
